(19) United States
(12) Patent Application Publication
(10) Pub. No.: US 2013/0282475 A1
(43) Pub. Date: Oct. 24, 2013

(54) SYSTEM AND METHOD FOR NOTIFYING AND PROVIDING A COUPON USING SNS INFORMATION

(71) Applicants: Kang Seuk Kim, Seoul (KR); Sang Ho Shin, Seoul (KR)

(72) Inventors: Kang Seuk Kim, Seoul (KR); Sang Ho Shin, Seoul (KR)

(73) Assignee: CJ E&M CORPORATION, Seoul (KR)

(21) Appl. No.: 13/993,836

(22) PCT Filed: Nov. 17, 2011
(86) PCT No.: PCT/KR11/08821

§ 371 Date: Jun. 13, 2013

(30) Foreign Application Priority Data
Dec. 23, 2010 (KR) 10-2010-0133689
Dec. 30, 2010 (KR) 10-2010-0138453

(51) Int. Cl. G06Q 30/02; G06Q 50/00

(52) U.S. Cl. CPC G06Q 30/0239; G06Q 50/01
USPC 705/14.39

(57) ABSTRACT

The present invention relates to a system and method for providing a coupon by using SNS information or providing a notification message related to the coupon. More specifically, the present invention rotates to a system and method for providing a coupon or providing a notification message to a receiver by inputting an SNS account or a relation of the receiver, or by inputting location information for using the coupon.

### TECHNICAL FIELD

The present invention relates to a system and method used in electronic commerce (e-commerce). More specifically, the present invention relates to a system and method for providing a coupon using social network service (hereinafter referred to as “SNS”) information or for providing a notification message related to the coupon and, more particularly, to a system and method for providing a coupon or providing a notification message to a receiver by inputting an SNS account or relationship of the receiver or by inputting information on the location where the coupon is used.

### BACKGROUND ART

With the recent increase in mashup services through SNSs, SNS users are gradually increasing. Most of the SNS provide open application programming interfaces (APIs), through which users can be linked, followed by a predetermined authentication, to utilize their SNS infrastructures, and thus numerous services are provided as a combination of value-added services using the SNS open APIs.

SNSs allow other users to view a word or content that a user has created and thus create a new mobile communication market. These SNSs have the greatest advantage in that they can perform a large amount of communications even with very limited resources.

SNSs have a great ripple effect on the mobile communication market. That is, the users can easily communicate with each other even when they know SNS accounts, particularly SNS IDs only, without telephone numbers, and thus the users who use short message services (SMSs) or multimedia message services (MMSs) through existing mobile communication terminals only for important and emergency purposes are gradually increasing.

Meanwhile, services for sending e-coupons via SMSs or MMSs through telephone numbers are currently widespread. However, in the case where these methods for sending e-coupons via SMSs or MMSs are used, if only one couple is sent, it will not be costly, but if it is to be sent to a great number of users, this will incur considerable costs and the coupon can be sent only when the users' telephone numbers are known, which are problematic.

Accordingly, if the e-coupons could be sent using SNSs even when only the SNS IDs are known, this would be very convenient.

However, in the case where the e-coupons are sent simply using SNSs, unlike the SMSs or MMSs in the mobile communication services that ensure the integrity of data transfer, the message delivery is not immediate in SNSs, it is difficult to ensure whether an application that can receive e-coupons is installed and whether the message is received, and the users tend to access the corresponding services only when they want, which are very problematic.

### DISCLOSURE

### Technical Problem

The present invention has been made to solve the above-described problems.

That is, in order to provide a coupon service that can be used at a coupon exchange site after authentication between a user terminal including a mobile communication terminal such as a smartphone and an SNS, it is necessary to provide a coupon authentication system under existing SNS environments, a method to allow a user to receive a coupon even when the user does not have access to a corresponding SNS account, and a measure to cope with a situation where an application is not installed, and thus an object of the present invention is to provide a system and method for meeting these needs.

Meanwhile, it can be said that the major base of the SNS is a mobile communication terminal, particularly a smartphone. Most smartphones are equipped with a GPS function and thus can transmit location information on the terminal under the user's approval. In the event of linkage with the SNS using the same, significant synergy effects are expected in the use of the coupons, and thus another object of the present invention is to provide a system and method for utilizing the same.

### Technical Solution

To achieve the above-described objects, the present invention provides a method for notifying and providing a coupon using SNS information. The method for notifying and providing the coupon according to the present invention may be operated in three modes such as a first mode, a second mode, and a third mode.

More specifically, the present invention provides a method for notifying and providing a coupon, the method comprising the steps of: (A) allowing any one of a first mode, a second mode, and a third mode to be input to a service server; (B1) if the first mode is input; to the service mode, allowing a coupon and a receiving SNS account to be input to the service server and transmitting, at the service server, the coupon to a terminal of the receiving SNS account; (B2) if the second mode is input to the service server, allowing a coupon and a receiving SNS relationship to be input to the service server, selecting, at the service server, one or more receiving SNS accounts which are in the input receiving SNS relationship, and transmitting, at the service server, the coupon to the terminal of the receiving SNS account; and (B3) if the third mode is input to the service server, allowing a coupon and a reference point to be input to the service server, receiving, at the service server, a location of a terminal of an SNS account registered user, and if the location of the terminal of the SNS account registered user is close to the reference point, transmitting, at the service server, an available coupon notification message to the SNS account registered user and the coupon to the terminal of the SNS account registered user.

Moreover, as another embodiment of the present invention, the first mode is slightly modified such that in step (B1), the step of allowing the coupon and the receiving SNS account to be input to the service server preferably comprises the steps of: allowing a coupon to be input to the service server; identifying, at the service server, location information on the input coupon; and selecting, at the service server, a receiving SNS account, which is close to the location information and has a high frequency of appearance, from a plurality of pre-stored SNS accounts.

Furthermore, as still another embodiment of the present invention, the second mode is slightly modified such that in step (B1), the step of allowing the coupon and the receiving SNS account to be input to the service server preferably comprises the steps of: allowing an SNS account to be input to the service server; identifying, at the service server, location information on the input receiving SNS account which has a high frequency of appearance; and selecting, at the service server, a coupon including location information, which is close to the location information, from a plurality of pre-stored coupons.

In addition, as yet another embodiment of the present invention, the third mode is slightly modified such that in step (B2), the step of allowing the coupon and the receiving SNS relationship to be input to the service server and selecting, at the service server, one or more receiving SNS accounts which are in the input receiving SNS relationship preferably comprises the steps of: allowing a coupon, a predetermined content, and a receiving SNS interchange with the content to be input to the service server; and selecting, at the service server, one or more receiving SNS accounts, which are in the receiving SNS interchange with the input content.

Additionally, steps (B1), (B2), and (B3) preferably comprise the step of (C1) determining, at the service server, whether the SNS account of the terminal has access to the service server.

Here, steps (B1), (B2), and (B3) preferably comprise, after step (C1), the step of (C2), if the SNS account of the terminal does not have access to the service server, transmitting, at the service server, a message including a coupon URL or an application download URL to the SNS account, the service server transmitting the coupon to a terminal equipped with the application.

Moreover, the method preferably comprises, after step (B1), (B2), or (B3), the steps of: (D1) allowing location information on the coupon to be input to the service server; (D2) receiving, at the service server, a location of the terminal; and (D3) if the location of the terminal is close to a location based on the location information on the coupon, transmitting, at the service server, a coupon availability notification message to the user.

To achieve the above-described objects, the present invention provides a system for notifying and providing a coupon using SNS information.

More specifically, the present invention provides a system for notifying and providing a coupon, the system comprising: a service server which is accessed through an SNS account, generates an available coupon notification message or a coupon availability notification message, or transmits the coupon; and a database which stores information on the SNS account that has access to the service server.

Moreover, the service server preferably comprises a location-based coupon recommendation module which generates and transmits an available coupon notification message to the user if a location of a terminal of the SNS account and a location based on location information on a pre-stored coupon are close to each other.

Furthermore, the service server preferably comprises a location-based coupon notification module which generates and transmits a coupon availability notification message to the user if a location of a terminal of the SNS account and a location based on location information on a coupon that the SNS account has are close to each other.

In addition, the service server preferably comprises an SNS authentication module which requests authentication of the SNS account from an SNS server if a request for login is received from the SNS account; and an SNS account access module which allows the access of the SNS account if the SNS server authenticates the SNS account.

Additionally, the service server preferably comprises an SNS coupon issue module which issues the coupon; an SNS coupon transmission module which transmits the coupon to a predetermined user; and an SNS coupon receiver authentication module which determines whether a receiver who is to receive the coupon is a predetermined receiver.

Moreover, the service server preferably comprises a user location analysis module which calculates location information on the terminal having a high frequency of appearance based on the location information on the terminal transmitted from the terminal of the SNS account to the service server.

Furthermore, the service server preferably comprises a coupon location assignment module which sets a coupon issue range which is spaced a predetermined distance from a reference point of a plurality of coupons input to the service server.

In addition, the coupon location assignment module preferably positions the plurality of coupons at location points determined by random numbers in coordinates of the coupon issue range.

Additionally, the service server preferably further comprises an SNS relationship information linkage module which requests and receives one or more other SNS accounts, which are in a predetermined SNS relationship with the SNS account, from an SNS server.

Moreover, the service server preferably further comprises an SNS interchange information linkage module which requests and receives one or more other SNS accounts, which are in a predetermined SNS interchange with content uploaded by the SNS account, from an SNS server.

Furthermore, the system preferably further comprises a coupon authentication server which compares a coupon which is used in a coupon exchange site with coupon information pre-stored in the database and determines authentication of the used coupon.

In addition, the terminal preferably transmits location information on the terminal to the service server. To this end, the terminal preferably has a GPS function or a WiFi positioning system (WPS) function, and the terminal is preferably a smartphone.

### Advantageous Effects

As described above, the conventional e-coupon can be sent only when the mobile communication terminal phone number or email address of the other party is known. However, according to the invention, the use of SNS information makes it possible to send the coupon only when the SNS account, particularly, the SNS ID is known.

Moreover, even when the user does not have access to the corresponding coupon service through the SNS authentication or the user does not subscribe to the corresponding coupon service, it is possible to determine whether the coupon is received and to normally send the coupon after having access to the SNS or subscribing the corresponding coupon service.

In addition, it is possible to provide the coupons by the SNS's common upload method without disclosure of personal information such as telephone number or email, and thus it is possible to effectively send the coupons.

Additionally, it is possible to maximize the use of the coupons using the location-based information. For example, in the case where a coupon is determined, it is possible to allow the corresponding coupon to be sent only to a user who is determined to stay close to the coupon exchange site, or in the case where a user is determined, it is possible to allow the user to collect coupons located adjacent to the user, thus maximizing the use of the coupons.

### DESCRIPTION OF DRAWINGS

FIG. 1 is a conceptual view illustrating a system for providing an SNS coupon according to the present invention.

FIGS. 2 and 3 are flowcharts illustrating a first mode as an embodiment of a method for providing an SNS coupon according to the present invention.

FIGS. 4 and 5 are flowcharts illustrating a second mode as another embodiment of the method for providing an SNS coupon according to the present invention.

FIGS. 6 and 7 are flowcharts illustrating a third mode as still another embodiment of the method for providing an SNS coupon according to the present invention.

FIG. 8 is a reference view illustrating the third mode.

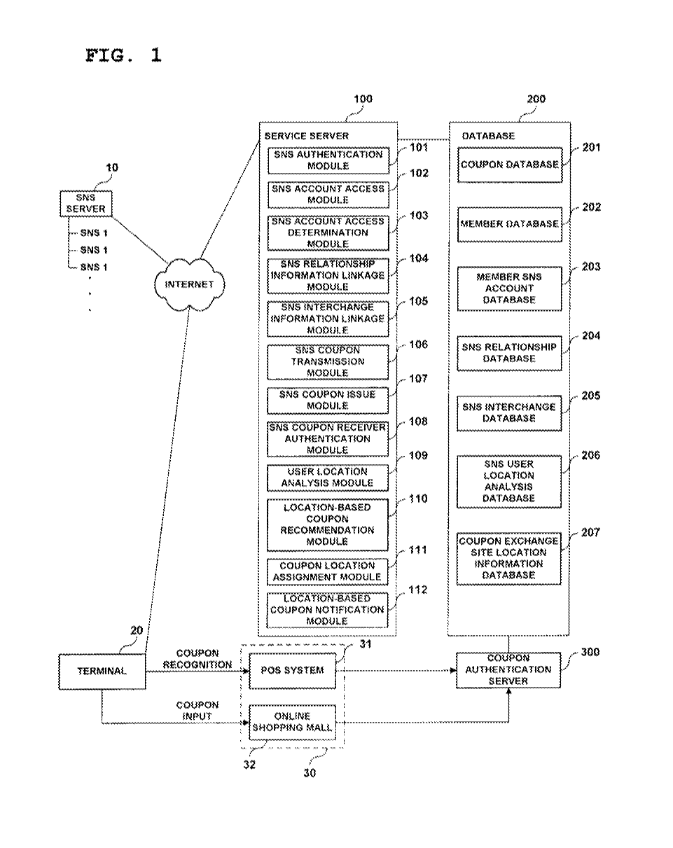

### MODE FOR INVENTION

### Definition of Terms

In the following description, the term “server” or “module” means a computing device that can perform data processing. In the following description, the server and module will be described with respect to their functions to facilitate understanding of the present invention, but it should be noted that they are not physically separated and located. For example, an SNS authentication module 101 and an SNS account access module 102 are individually described to facilitate the understanding of the present invention, but two or more functions can be, of course, performed by a single processing unit.

In the following description, it should be noted that the term “Internet” is a concept that includes both wired and wireless connections.

As used herein, the term “social network service (SNS)” refers to a service that provides a platform that allows a plurality of users to create readable content on online or connects a network with existing personal connections or unspecified people on online. The creation of content includes the uploading of certain data as well as the writing of a word and generally allows unspecified individuals including acquaintances to share and spread information.

Generally, SNS relationships are established between multiple users at the request of the users in the SNS, which thus makes it possible to allow a user to create content and then allow other users in a predetermined SNS relationship to read the corresponding content.

In other words, the term “SNS relationship” is defined as a unidirectional or bidirectional connection established between a user and other users on the SNS. The SNS relationship is a general term commonly used at present and may require an approval of an SNS manager or not depending on the type of SNS. For example, the SNS relationship includes follower/following on Twitter, friends on Facebook, etc.

Meanwhile, As used herein, the term “SNS interchange” is defined a certain response to content, which is uploaded by a user of an SNS account, by another user of another SNS account, in such a manner that the user of another SNS account in the SNS relationship propagates the content to the user's SNS relationships or expresses a response or preference to the content. The first user in the SNS interchange may be a user of an SNS account who has established the SNS relationship with the user of the SNS account who has uploaded the content. However, other users of SNS accounts having no SNS relationship may participate in the SNS interchange unless the user does not impose any limitation. For example, the SNS interchange includes Retweet, Reply, etc. on Twitter, I Like it, Reply, etc. on Facebook, etc.

Meanwhile, the term “SNS coupon” means a coupon that is sent using SNS data, and the term “SNS data” means information on a user having an account on the SNS.

Meanwhile, the term “SNS account” means an ID separate from other accounts on the SNS. A single user may use a plurality of SNS accounts on one SNS. In the following description, the SNS account user refers to a person who currently has access using the SNS account.

As used herein, the term “terminal” refers to an information processing device that can be used by an individual user and is equipped with a wired or wireless communication function. For example, the terminal may be a computer such as a desktop, notebook, etc. or a mobile communication terminal such as a smart pad, smartphone, etc. As used herein, the term “smartphone” refers to a mobile communication terminal that is equipped with a call function, a communication function, and a data processing function and thus can execute an application program and access the Internet. Moreover, in the present invention, it is preferable that the “terminal” has a function of transmitting location information, on the terminal, and thus it is preferable that the terminal has a GPS function or a WiFi positioning system (WPS) function that can transmit location information using WiFi.

As used herein, the term “application” refers to an application program that can be executed by the terminal. It is a concept that includes an application program that can be executed by a computer as well as an application that can be executed by a smartphone.

As used herein, the term “coupon” means an electronic coupon (e-coupon) and there is, of course, no limitation in the written information and in the field and benefit from the use of the same. The issue of a coupon is a concept that includes the creation of a coupon.

Meanwhile, the term “location information on a coupon” or “location information included on a coupon” refers to information related to the location included or recorded on the coupon and may be represented in the form of coordinates. For example, the location information on the coupon includes the location of a coupon exchange site 30, which may be included or recorded on the coupon.

In the following description, the sentence “a service server sends a message to an SNS account” means that the service server sends a message to a predetermined SNS account using the existing SNS, and the user of the SNS account can access the SNS account through the terminal and view the message.

In the following description, the sentence “a service server sends a coupon to a terminal of an SNS account” means that an application that can download the coupon is installed in the terminal of the SNS account user such that the service server can directly send a coupon to the terminal through the application, and thus the user of the SNS account can receive, view, and/or store the coupon in the terminal even when the user does not subscribe to the corresponding coupon service.

As used herein, the term “available coupon notification message” means a message notifying that the user can download a new coupon.

As used herein, the term “coupon availability notification message” means a message notifying that the coupon that the user already has can be used.

### 1. System for Notifying and Providing SNS Coupon

A system for notifying and providing an SNS coupon according to the present invention comprises a service server 100 and a database 200 and may further comprise a coupon authentication server 300.

The service server 100 may be connected to an SNS server 10 and a terminal 20 of a user via the Internet. The SNS server 10 means a server of each of various SNSs, which manages the SNS and authenticates the access of the user. The SNS server connected to the system according to the present invention may be a plurality of servers SNS1, SNS2, SNS3, etc.

The service server 100 may be connected to the terminal 20 of the user via the Internet. As mentioned above, the terminal 20 of the user includes a mobile terminal such as a mobile communication terminal, smart pad, notebook, etc. as well as a personal computer such as a desktop. In an embodiment, the terminal 20 of the user may be a smartphone that can identify and transmit location information.

A coupon exchange site 30 is a place where the coupon can be used and may be a certain offline place provided with a point of sale (POS) system 31 or an online exchange place such as an online shopping mall.

The SNS server 10, the terminal 20, and the coupon exchange site 30 are known in the prior art, and thus a detailed description of their configuration and function will be omitted in this specification.

It is preferable that the service server 100 is provided with a web server and a communication server to serve to provide a coupon service through the SNS and is linked to a database 200 that can store information related to user authentication and/or coupon issue.

The user may log into the service server 100 using an SNS account, and then the service server 100 may authenticate the account using an open API provided by the SNS and store the result in the database 200. A plurality of SNS accounts may be assigned to one user and stored.

Specifically, the service server 100 may comprise an SNS authentication module 101, an SNS account access module 102, an SNS account access determination module 103, an SNS relationship information linkage module 104, an SNS interchange information linkage module 105, an SNS coupon transmission module 106, an SNS coupon issue module 107, an SNS coupon receiver authentication module 108, a user location analysis module 109, a location-based coupon recommendation module 110, a coupon location assignment module 111, and a location-based coupon notification module 112.

The SNS authentication module 101 allows a user having an SNS account to log into the service server 100 with the SNS account and serves to authenticate the access of the corresponding account by inquiring of the associated SNS server 10.

The SNS account access module 102 serves to allow the SNS account authenticated by the SNS authentication module 101 to access the service server 100.

The SNS account access determination module 103 serves to determine whether the SNS account currently has access to the service server 100.

The SNS relationship information linkage module 104 serves to bring other SNS accounts, which are in the SNS relationship with the user's SNS account, from the SNS server 10 either automatically or manually, at the request of the user, to the service server 100 and store the corresponding SNS accounts in an SNS relationship database 204 of the database 200.

The SNS interchange information linkage module 105 serves to bring other SNS accounts, which respond to content such as a word uploaded by the user's SNS account, i.e., which have interchanges with the corresponding content, from the SNS server 10 either automatically or manually, at the request of the user, to the service server 100 and store the corresponding SNS accounts in an SNS interchange database 205 of the database 200.

The SNS coupon issue module 107 serves to issue a coupon using a lot of information (for example, coupon expiration date, coupon exchange site, coupon product, discount benefit, coupon image, forward message, issue price, and other information) that can be recorded on the coupon, at the request of a user who wants the coupon issue, and store the coupon in a coupon database 201 of the database 200. Of course, the present invention is not limited to the information recorded on the coupon.

The SNS coupon transmission module 106 serves to send a registered coupon to a designated receiving SNS account or transmit a message including a coupon URL or an application download URL, at which the coupon can be verified, to the SNS account.

The SNS coupon receiver authentication module 108 serves to authenticate whether the user who has received the coupon is a receiver after accessing the user's SNS account or a user who can receive the coupon and finally send the coupon.

The user location analysis module 109 serves to analyze the location range of the user of the SNS account based on location information, which is left by a user who has subscribed to the service server 100 more than once or a user who has established the SNS relationship with the user, location information, which is transmitted to the service server 100, and location information, at which the coupon is used, and stores the information in an SNS user location analysis database 206 of the database 200.

The location-based coupon recommendation module 110 serves to recommend a coupon having location information to a user who is close to the location.

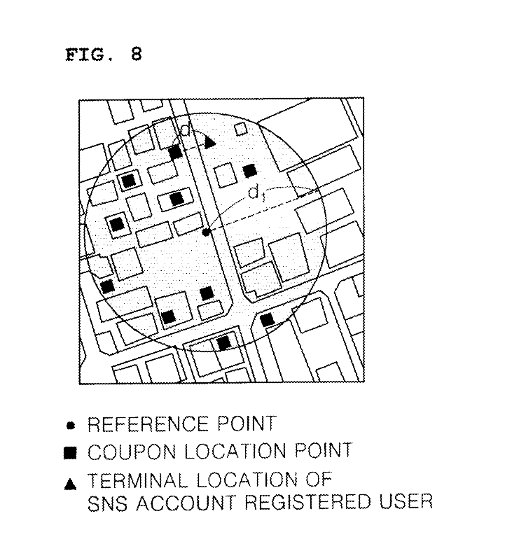

The coupon location assignment module 111 serves to designate one or more reference points and distance ranges, which are displayed on a map, set a coupon issue range A based on a circle within a radius of the distance range based on the reference point or cased on vertices of a regular polygon such as an equilateral triangle within the distance range, assign location coordinates of a predetermined number of coupons within the set range, and issue the coupons (see FIG. 8).

When a user who already has a coupon is within a predetermined range of the coupon exchange site 30 of the coupon, the location-based coupon notification module 112 serves to notify the user that the coupon exchange site 30 is around the user.

The database 200 may comprise a coupon database 201, a member database 202, a member SNS account database 203, an SNS relationship database 204, an SNS interchange database 205, an SNS user location analysis database 206, and a coupon exchange site location information database 207.

The coupon database 201 serves to store coupons issued by the SNS coupon transmission module 106 of the service server 100.

The member database 202 serves to store a variety of information on members of the present system.

The member SNS account database 203 serves to store information on the SNS accounts of the members of the present system. The service serve 100 of the present system can access the SNS accounts after login and authentication of the SNS server 10 and, in the process, the information on the SNS accounts can be stored.

The SNS relationship database 204 serves to store other SNS accounts in a predetermined relationship that the SNS relationship information linkage module 104 has brought either automatically or manually, at the request of the user.

The SNS interchange database 205 serves to store other SNS accounts in a predetermined interchange that the SNS interchange information linkage module 105 has brought either automatically or manually, at the request of the user.

The SNS user location analysis database 206 serves to store information analyzed by the user location analysis module 109.

The coupon exchange site location information database 207 serves to store location information on the coupon exchange site 30 at which the coupon is used.

When an issued coupon is input from the coupon exchange site 30 such as an offline POS system 31 or an online shopping mall 32, the coupon authentication server 300 serves to compare the input coupon with coupon information pre-stored in the database 200 to determine whether the corresponding coupon is available and deliver product information or benefit related to the coupon.

Next, a method for notifying and providing an SNS coupon according to the present invention based on the above-described system for notifying and providing the SNS coupon will be described with respect to various embodiments.

### 2. Method for Notifying and Providing SNS Coupon

A method for notifying and providing an SNS coupon according to the present invention may notify or provide an SNS coupon by various methods. Among others, the method of the present invention will be described in detail based on the following three methods.

### (1) User's SNS Account and Access to Service Server Using the Same

A user may request a login from the SNS authentication module 101 of the service server 100 through an SNS account.

The SNS authentication module 101 of the service server 100 requests account authentication from, the SNS server 10 and, if authenticated, the access is approved by the SNS account access module 102 of the service server 100. The information and SNS account of the accessed user may be stored in the member database 202 and the member SNS account database 203, respectively.

The SNS account, access determination module 103 of the service server may determine whether the SNS account has access.

The SNS relationship information linkage module 104 of the service server may request SNS relationship information on the accessed SNS account from the SNS server 10, and the transmitted information may be stored in the SNS relationship database 204 of the database 200.

### (2) First Mode: Designation of Receiving SNS Account

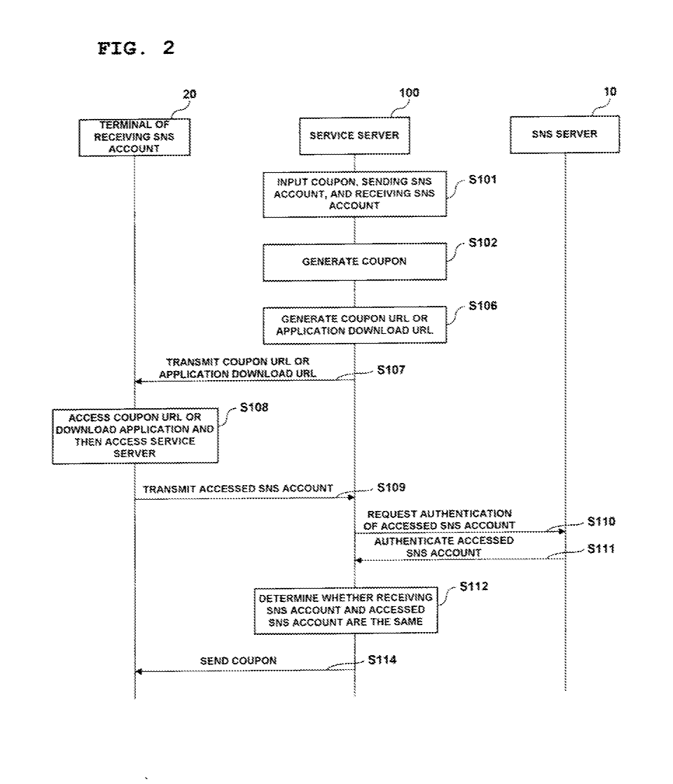

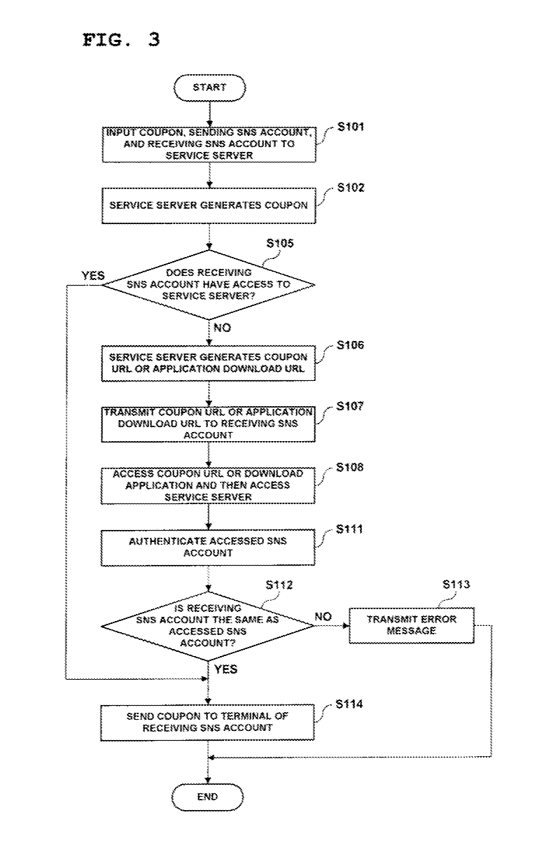

A method for notifying and providing an SNS coupon in a first mode according to the present invention will be described with reference to FIGS. 2 and 3.

The first mode is to provide a coupon in the case where a user particularly designates a receiving SNS account.

First, the user inputs a coupon to be issued and a receiving SNS account to the service server 100 (S101). The user may further input a sending SNS account. For example, the user may select the coupon to be issued from already registered coupons and may input information which should be input on the coupon, but the present invention is, of course, not limited to the method for selecting the coupon or the type of information input on the coupon. Moreover, for example, the user may directly input the information to the service server 100 through the SNS account or may access the service server 100 through the SNS account to input the information, but the present invention is not limited to the input method.

Then, the SNS coupon issue module 107 of the service server 100 generates a coupon (S102). It should be noted that the case where the user selects the coupon to be issued from the already registered coupons is also included in the coupon generation step of S102.

Next, the SNS account access determination module 103 of the service server 100 determines whether the receiving SNS account has access to the service server 100 according to the present invention (S103). The accessed state means that an application through which the coupon can be downloaded is installed in the terminal 20 of the receiving SNS account.

If accessed, the coupon is sent to the terminal 20 of the receiving SNS account through the corresponding application, and thus the procedure for providing the coupon is terminated (S114).

However, if not accessed, it is impossible to determine whether the corresponding application is installed and determine when the user can verify the coupon, and thus a separate message is generated and transmitted to the receiving SNS account.

More specifically, the service server 100 generates a coupon URL or an application download URL (S106) and transmits it to the receiver SNS account (S107). For example, the message may be described in the SNS itself, transmitted as an email registered at the SNS account, or transmitted as an SMS or MMS to a mobile communication terminal registered at the SNS account, but it should be noted that the present invention is not limited to these message transmission methods.

When the coupon URL is transmitted, the user of the receiving SNS account may identity and access the coupon URL, and when the application download URL is transmitted, the user of the receiving SNS account may download the corresponding application and then access the service server 100 through the application (S108).

At this time, information on the accessed SNS account (hereinafter referred to as an “accessed SNS account”) is transmitted to the service server 100 (S109), and the service server 100 determines whether the accessed SNS account is the same as the receiving SNS account to which the coupon is to be provided.

More specifically, the SNS coupon receiver authentication module 108 of the service server 100 inquires whether the accessed SNS account actually exists, i.e., requests authentication of the accessed SNS account from the SNS server 10 (S110). If the authentication of the accessed SNS account fails, an error message is generated and transmitted, and the procedure is terminated.

When the service server 100 identifies the authentication of the accessed SNS account, from the SNS server 10 (S111), the service server 100 determines whether the accessed SNS account is the same as the receiving SNS account input in step S101 (S112). If not, an error message is generated and transmitted, and the procedure is terminated (S113).

When the accessed SNS account is identified with these procedures, the accessed SNS account is the receiving SNS account, and in addition, the terminal of the receiving SNS account can receive a coupon, and thus the coupon is sent to the terminal of the receiving SNS account (S114).

### (3) Another Embodiment of First Mode: Recommendation of Receiving SNS Account After Input of Coupon

As another embodiment of the first mode, the user may input a receiving SNS account only, may not input a coupon, and may receive a recommendation from the service server 100. That is, steps S101 and S102 in this embodiment are somewhat different from those in the embodiment shown in FIGS. 2 and 3.

The user inputs a receiving SNS account to the service server 100 and selects a recommendation function without inputting a coupon or its information.

In this case, the location-based coupon recommendation module 110 of the service server 100 searches the SNS user location analysis database 206 related to the user of the receiving SNS account to calculate a high-frequency location, where the user of the receiving SNS account is statistically located, searches the coupon exchange site location information database 207 to select the location of a coupon exchange site 30 close to the calculated location, and then generates a coupon, which can be used at the coupon exchange site 30, as a coupon to be sent to the SNS account.

The steps after S106 are performed in a manner similar to that described above.

According to another embodiment of the first mode, it is possible to select a coupon which is most likely to be used or a receiving SNS account by which the coupon is most likely to be used.

### (4) Still Another Embodiment of First Mode: Recommendation of Coupon After Input of Receiving SNS Account

As still another embodiment of the first mode, the user may input a coupon only, may not input a receiving SNS account, and may receive a recommendation from the service server 100. Likewise, steps S101 and S102 in this embodiment are somewhat different from those in the embodiment shown in FIGS. 2 and 3.

The user inputs a coupon to the service server 100 and selects a recommendation function without inputting a receiving SNS account.

Here, it is preferable that the coupon is used at an offline exchange site, instead of the online shopping mall 32. The exchange site of the input coupon may be identified by searching the coupon exchange site location information database 207.

The location-based coupon recommendation module 110 of the service server 100 searches the SNS user location analysis database 206 to select a receiving SNS account, which has a high statistical frequency at the exchange site of the coupon, from a plurality of SNS accounts.

The steps after S106 are performed in a manner similar to that described above.

According to still another embodiment of the first mode, it is possible to select a coupon which is most likely to be used or a receiving SNS account by which the coupon is most likely to be used.

### (5) Second Mode: Designation of Receiving SNS Relationship

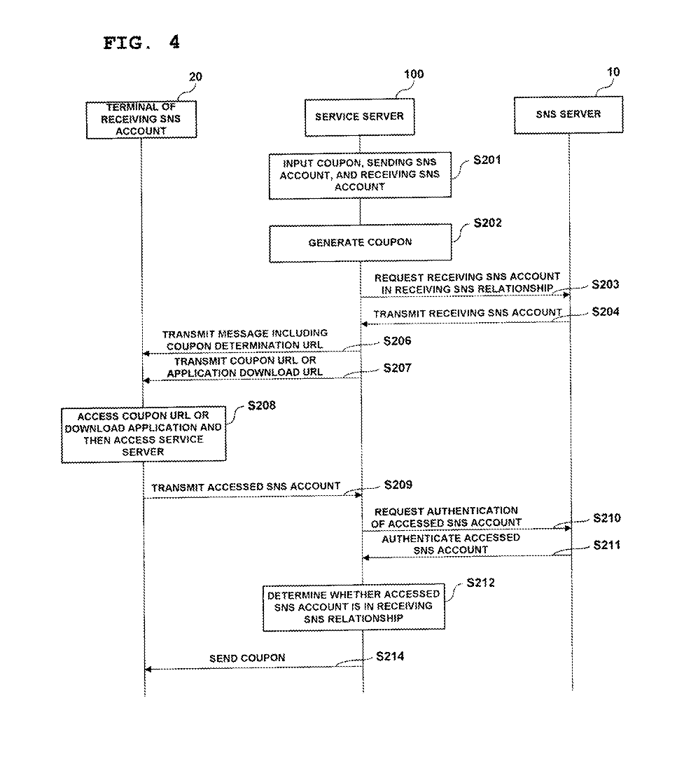

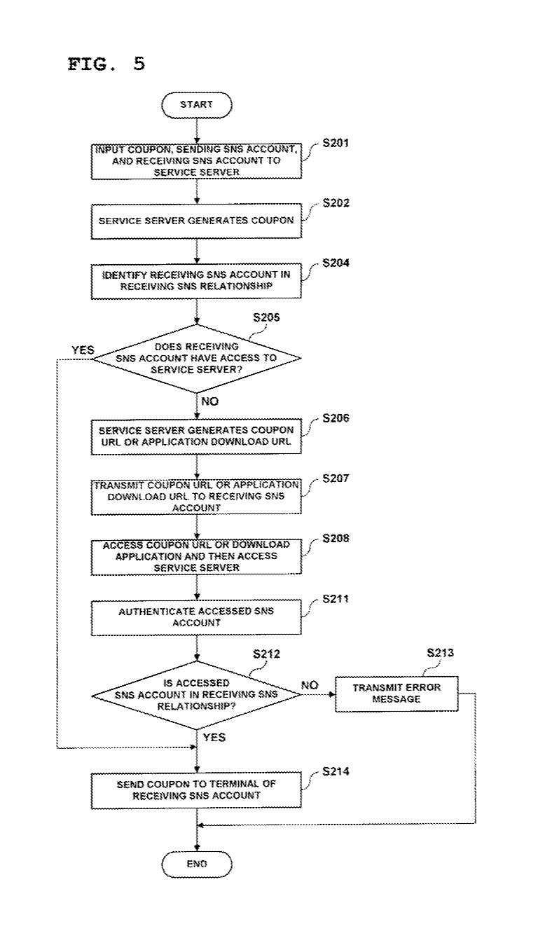

A method for notifying and providing an SNS coupon in a second mode according to the present invention will be described with reference to FIGS. 4 and 5.

The second mode is to provide a coupon in the case where a user designates a receiving SNS relationship only.

First, the user inputs a coupon to be issued and a relationship with a receiving SNS from which the coupon is to be received (hereinafter referred to as a “receiving SNS relationship”) (S201). The user may further input a sending SNS account. As mentioned above, the present invention is, of course, not limited to the method for selecting the coupon, the type of information input on the coupon, and the input method.

Then, the SNS coupon issue module 107 of the service server 100 generates a coupon (S202). As mentioned above, it should be noted that the case where the user selects the coupon to be issued from the already registered coupons is also included in the coupon generation step of S202.

Next, information on the receiving SNS account in the receiving SNS relationship input in step S201 is requested from the SNS server 10 (S203) and received (S204). There may be one or more receiving SNS accounts which are in the receiving SNS relationship. In another embodiment, when the information is stored in the SNS relationship database 204 of the database 200, the corresponding information may be utilized without requesting from the SNS server 10.

Next, it is determined whether the receiving SNS account identified in step S204 has access (S205), if accessed, the service server 100 sends a coupon to the terminal of the receiving SNS account (S214) and, if not accessed, the service server 100 generates and transmits a coupon URL or an application download URL, as mentioned in the first mode, to receive an accessed SNS account and request authentication (S206 to S210).

When the service server 100 identifies the authentication of the accessed SNS account from the SNS server 10 (S211), the service server 100 determines whether the accessed SNS account is in the receiving SNS relationship input in step S201 (S212). If not, an error message is generated and transmitted, and the procedure is terminated (S213).

When the accessed SNS relationship is identified with these procedures, the accessed SNS account is the receiving SNS account in the receiving SNS relationship, and in addition, the terminal of the receiving SNS account can receive a coupon, and thus the coupon is sent to the terminal of the receiving SNS account (S214).

### (6) Another Embodiment of Second Mode: Designation of Receiving SNS Interchange

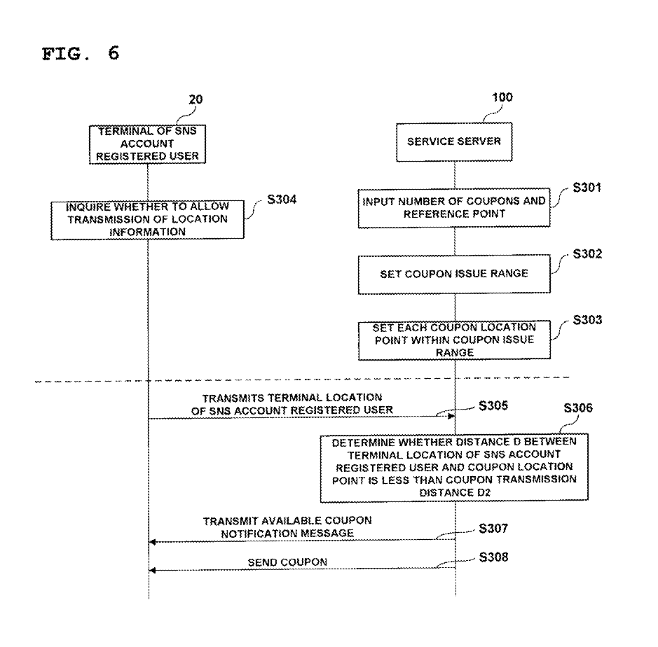

As another embodiment of the second mode, the user may designate a receiving SNS interchange only, instead of the receiving SNS relationship, thus providing the coupon. That is, steps S201, S203, S204, and S212 in this embodiment are somewhat different from those in the embodiment shown in FIGS. 4 and 6. The modified steps will be referred to as steps S201′, S203′, S204′, and S212′ (not shown).

A method for notifying and providing an SNS coupon in another embodiment of the second mode according to the present invention will be described with reference to FIGS. 4 and 5.

First, the user designates a coupon to be issued and a target content from which the coupon is to be received and inputs an interchange with a receiving SNS which responds the corresponding content (hereinafter referred to as a “receiving SNS interchange”) (S201′). The user may further input a sending SNS account. As mentioned above, the present invention is, of course, not limited to the method for selecting the coupon, the type of information input on the coupon, and the input method.

Then, the SNS coupon issue module 107 of the service server 100 generates a coupon (S202). As mentioned above, it should be noted that the case where the user selects the coupon to be issued from the already registered coupons is also included in the coupon generation step of S202.

Next, information on the receiving SNS account in the receiving SNS interchange with the content input in step S201′ is requested from the SNS server 10 (S203′) and received (S204′). There may be one or more receiving SNS accounts which are in the receiving SNS interchange. In another embodiment, when the information is stored in the SNS interchange database 205 of the database 200, the corresponding information may be utilized without requesting from the SNS server 10.

Next, it is determined whether the receiving SNS account identified in step S204′ has access (S205), if accessed, the service server 100 sends a coupon to the terminal of the receiving SNS account (S214) and, if not accessed, the service server 100 generates and transmits a coupon URL or an application download URL, as mentioned in the first and second mode, to receive an accessed SNS account and request authentication (S206 to S210).

When the service server 100 identities the authentication of the accessed SNS account from the SNS server 10 (S211), the service server 100 determines whether the accessed SNS account is in the receiving SNS interchange input in step S201 (S212′). If not, an error message is generated and transmitted, and the procedure is terminated (S213).

When the accessed SNS interchange is identified with these procedures, the accessed SNS account is the receiving SNS account in the receiving SNS interchange, and in addition, the terminal of the receiving SNS account can receive a coupon, and thus the coupon is sent to the terminal of the receiving SNS account (S214).

### (7) Third Mode: Designation of Coupon Location

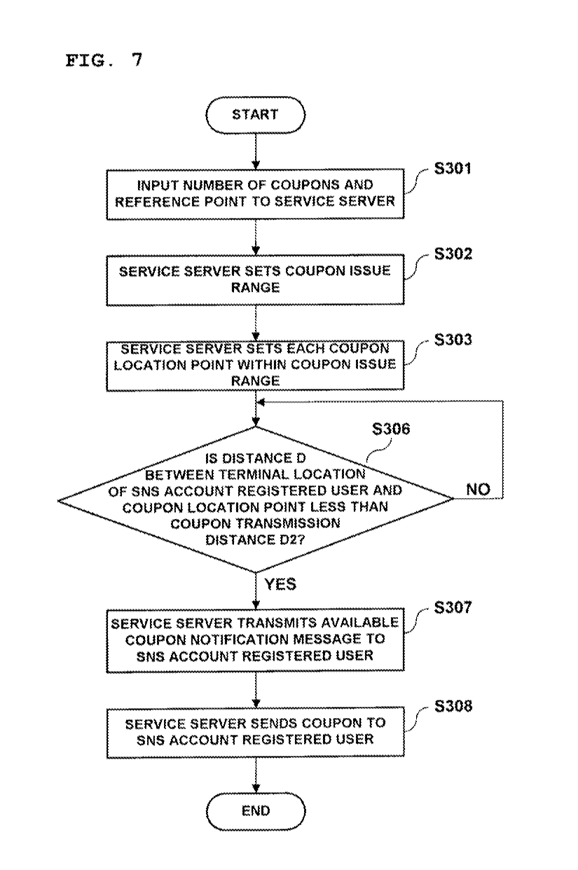

A method for notifying and providing an SNS coupon in a third mode according to the present invention will be described with reference to FIGS. 6 to 8.

The third mode is to provide a coupon to a user, who is located at a predetermined location and does not input a receiving SNS account or relationship, when the location of the coupon is input.

First, a reference point, on which the number of coupons and the issue of the coupons are based, is input to the service server 100 (S301). In an example shown in FIG. 8, the reference point is shown as a circular dot. It is preferable that the reference point is input in the form of coordinates. In an embodiment, the reference point may be the location of the coupon exchange site 30 of the corresponding coupon.

Then, the coupon location assignment module 111 of the service server 100 sets a coupon issue range A based on the input reference point in a predetermined manner (S302). For example, as shown in FIG. 8, the coupon issue range A may be set as a circle having a predetermined radius d1 based on the reference point. Otherwise, the coupon issue range A may be set as a regular polygon such as an equilateral triangle or square within a predetermined distance. The coupon issue range A is significant to the setting of a predetermined range within which the coupon is to be issued, and thus it should be noted that the present invention is not limited to the type or size of the issue range.

Next, coupon location points are randomly set by the number of coupons input in step S301 within the coupon issue range A. For example, the random positioning of the coupon location points may use random numbers with limits in the coordinates of the coupon issue range A, but the present invention is not limited thereto. In the example shown in FIG. 8, a total of ten coupon location points are shown as square acts.

Meanwhile, it may be preferable that the step (S304) of inquiring whether to allow the transmission of location information is performed in advance in a terminal 20 of an SNS account registered user. In particular, as mentioned above, it is preferable that the terminal 20 of the SNS account registered user has a GPS function or a WPS function that can transmit the location information, and a smartphone with this function is more preferred.

The preparation for the coupon issue is completed with these procedures.

Then, the terminal 20 of the SNS account registered user transmits the location information on the terminal 20 depending on the movement of the user, i.e., depending on the movement of the terminal 20 at a predetermined time interval to the service server 100 (S305).

If the distance d between the location of the terminal 20 transmitted in step S305 and a coupon location point, which is closest to the terminal 20 among a plurality of coupon location points, is less than a predetermined coupon transmission distance d₂ (S306), i.e., if the SNS account registered user is close to the coupon location point, the service server 100 generates and transmits an available coupon notification message to the corresponding SNS account (S307). As mentioned above, the present invention is not limited to the message transmission method.

Then, the service server 100 sends a prepared coupon to the terminal 20 of the SNS account registered user (S308).

The method for sending the coupon may be made according to the steps described in the first and second modes.

### (8) Method for Notifying Coupon

As mentioned above, it is possible to issue the coupon to the user by various methods. In addition, according to the present invention, it is possible to notify the user who already has the coupon that the coupon exchange site 30 is around the user.

It is preferable that, the location information such as the coupon exchange site 30 is included in the coupon, and the location of the user may be identified by the terminal 20 that can transmit the location information.

The coupon that the user has and the location information included therein are transmitted to the service server 100 and stored in the database.

The location information on the user's terminal 20 is periodically transmitted to the service server 100.

The location-based coupon notification module 112 of the service server 100 compares the location of the terminal periodically received from the user's terminal with the location corresponding to the location information included in the coupon that the user has and, if the distance between the locations is close, that is, within a predetermined distance, generates and transmits a coupon availability notification message to the user.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1-45. (canceled)

46. A method for notifying and providing a coupon, the method comprising the steps of:
(a) allowing a coupon and a reference point to be input to a service server;
(b) receiving, at the service server, a location of a terminal of an SNS account registered user; and
(c) if the location of the terminal of the SNS account registered user is close to the reference point, transmitting, at the service server, an available coupon notification message to the SNS account registered user.

47. The method of claim 46, wherein step (a) comprises the step of (a1) setting, at the service server, a coupon issue range which is spaced a predetermined distance from the reference point.

48. The method of claim 47, wherein step (a) further comprises the step of allowing the number of coupons to be input to the service server and further comprises, after step (a1), the step of (a2) positioning the input number of coupons at location points within the coupon issue range.

49. The method of claim 48, wherein the location points in step (a2) are determined by random numbers in coordinates of the coupon issue range.

50. The method of claim 48, wherein step (c) comprises the steps of (c1), if the distance d between the location of the terminal of the SNS account registered user and the location point is less than a predetermined coupon transmission distance d₂, determining, at the service server, that the location of the terminal of the SNS account registered user is close to the reference point.

51. The method of claim 46, wherein step (c) comprises the step of (c2) transmitting, at the service server, the coupon to the terminal of the SNS account registered user.

52. The method of claim 47, wherein step (c) comprises the step of (c2) transmitting, at the service server, the coupon to the terminal of the SNS account registered user.

53. The method of claim 48, wherein step (c) comprises the step of (c2) transmitting, at the service server, the coupon to the terminal of the SNS account registered user.

54. The method of claim 49, wherein step (c) comprises the step of (c2) transmitting, at the service server, the coupon to the terminal of the SNS account registered user.

55. The method of claim 50, wherein step (c) comprises the step of (c2) transmitting, at the service server, the coupon to the terminal of the SNS account registered user.

56. The method of claim 51, wherein step (c) comprises, before step (c2), the step of (c3) determining, at the service server, whether the SNS account has access to the service server.

57. The method of claim 52, wherein step (c) comprises, before step (c2), the step of (c3) determining, at the service server, whether the SNS account has access to the service server.

58. The method of claim 53, wherein step (c) comprises, before step (c2), the step of (c3) determining, at the service server, whether the SNS account has access to the service server.

59. The method of claim 54, wherein step (c) comprises, before step (c2), the step of (c3) determining, at the service server, whether the SNS account has access to the service server.

60. The method of claim 55, wherein step (c) comprises, before step (c2), the step of (c3) determining, at the service server, whether the SNS account has access to the service server.

61. A method for notifying a coupon, the method comprising the steps of:
(d) allowing location information of a coupon, which an SNS account registered user has, to be input to a service server;
(e) receiving, at the service server, a location of a terminal of the SNS account registered user; and
(f) if the location of the terminal of the SNS account registered user is close to a location based on the location information on the coupon, transmitting, at the service server, a coupon availability notification message to the SNS account registered user.

62. The method of claim 61, wherein step (i) comprises the step of, if the distance between the location of the terminal of the SNS account registered user and the location based on the location information on the coupon is less than a predetermined distance, determining, at the service server, that the location of the terminal of the SNS account registered user and the location based on the location information on the coupon are close to each other.

63. A system for notifying and providing a coupon, the system comprising:
a service server which is accessed through an SNS account, generates an available coupon notification message or a coupon availability notification message, or transmits the coupon; and
a database which stores information on the SNS account that has access to the service server,
wherein the service server comprises:
a location-based coupon recommendation module which generates and transmits an available coupon notification message to a user if a location of a terminal of the SNS account and a location based on location information on a pre-stored coupon are close to each other; and
a location-based coupon notification module which generates and transmits a coupon availability notification message to the user if the location of the terminal of the SNS account and a location based on location information on a coupon that the SNS account has are close to each other.

64. The system of claim 63, wherein the service server further comprises a user location analysis module which calculates location information on the terminal having a high frequency of appearance based on the location information on the terminal transmitted from the terminal of the SNS terminal to the service server.
